(19) United States
(12) Patent Application Publication
(10) Pub. No.: US 2025/0092879 A1
(43) Pub. Date: Mar. 20, 2025

(54) COMPRESSOR FOR A FUEL-CELL SYSTEM, AND FUEL-CELL SYSTEM HAVING SAME

(71) Applicant: ZF CV Systems Global GmbH, Bern (CH)

(72) Inventor: Janik Ricke, Uetze (DE)

(21) Appl. No.: 18/968,867

(22) Filed: Dec. 4, 2024

Related U.S. Application Data
(63) Continuation of application No. PCT/EP2023/063050, filed on May 16, 2023.

(30) Foreign Application Priority Data
Jun. 9, 2022 (DE) 10 2022 114 460.7

(51) Int. Cl. F04D 29/046; F04D 29/32; F04D 29/52; H01M 8/04111

(52) U.S. Cl. CPC F04D 29/046; F04D 29/321; F04D 29/522; H01M 8/04111; H01M 2250/20

(57) ABSTRACT

A compressor is for a fuel cell system, in particular a fuel cell system of a utility vehicle. The compressor includes a compressor housing, a compressor wheel, a rotationally driven compressor shaft which is operatively connected to the compressor wheel, and a bearing arrangement which supports the compressor shaft in the compressor housing so as to be rotatable about an axis of rotation, wherein the bearing arrangement includes an axial air bearing for absorbing axial forces between the compressor housing and the compressor shaft. The axial air bearing is a first axial air bearing, and the bearing arrangement also includes a second axial air bearing which is arranged at an axial spacing from the first axial air bearing and is additionally configured to absorb axial forces between the compressor housing and the compressor shaft.

### CROSS-REFERENCE TO RELATED APPLICATIONS

This application is a continuation application of international patent application PCT/EP2023/063050, filed May 16, 2023, designating the United States and claiming priority from German application 10 2022 114 460.7, filed Jun. 9, 2022, and the entire content of both applications is incorporated herein by reference.

### TECHNICAL FIELD

The present disclosure relates to a compressor for a fuel cell system, in particular for a fuel cell system of a utility vehicle, including a compressor housing, a compressor wheel, a rotationally driven compressor shaft which is operatively connected to the compressor wheel, and a bearing arrangement which supports the compressor shaft in the compressor housing so as to be rotatable about an axis of rotation, wherein the bearing arrangement includes an axial air bearing for absorbing forces between the compressor housing and the compressor shaft (below also: axial forces).

### BACKGROUND

For correct operation, fuel cell systems generally require a controlled feed of air to the cathode side, in order to be able to maintain within the fuel cells, what is known as the stack, the reactant equilibrium that is optimal for the operation of the fuel cell system. It is known to compress the air by means of one or more compressors and to thus feed a controlled mass flow or volume flow of air to the fuel cell.

The higher the power to be generated by the fuel cell, the higher generally the necessary mass flow or volume flow which must be delivered by the compressor or compressors is. During the operation of the compressor, the process for drawing in the air produces an axial force which acts on the compressor shaft. As the speed of the compressor shaft and of the compressor wheel increases, so too—given a constant cross section—does the quantity of air drawn in and thus the pressure built up, and thus also the axial force. This effect is more greatly pronounced in single-stage compressors than in two-stage compressors, in which the axial forces at least partially cancel out.

If the axial force becomes too high for the bearing means used, increased wear occurs, particularly at the speeds which then prevail. The axial forces that arise must therefore be absorbed by the bearing arrangement in all compressor systems so that undesirably high wear between the rotating elements and the stationary elements in the compressor does not occur. Owing to the high speeds of the compressors mentioned in the introduction during operation, it has already proven to be successful in the past to use an axial air bearing in the bearing arrangement, the axial air bearing being intended to be used to absorb the axial forces that arise between the compressor shaft and the compressor housing.

Two-stage compressors can usually compensate for the axial forces that arise to a sufficient extent using an axial air bearing. However, the installation space occupied by the two-stage compressors owing to their configuration principle is regarded as a challenge particularly against the background of increasingly restricted space offered in vehicles. For applications in passenger cars, two-stage compressors are therefore usually unsuitable, and even in utility vehicles installation space is becoming increasingly tight owing to technological development.

### SUMMARY

Against this background, it is an object of the disclosure to specify a compressor in which the disadvantages described above are mitigated as far as possible. In particular, the disclosure was based on the object of improving a compressor such that axial forces acting on the compressor shaft can be better absorbed and the compressor at the same time takes up the smallest possible necessary installation space. More particularly, the disclosure was based on the object of realizing the foregoing as cost-effectively as possible.

The above object is, example, achieved via a compressor according to the disclosure. The disclosure in particular proposes that, in a compressor, the axial air bearing is a first axial air bearing, and the bearing arrangement also includes a second axial air bearing which is arranged in the direction of the axis of rotation (below also: axial direction) at a spacing from the first axial air bearing and (in addition to the first axial air bearing) is configured to absorb forces between the compressor housing and the compressor shaft in the direction of the axis of rotation, that is, axial forces. In other words, according to the disclosure, both the first axial air bearing and a second axial air bearing are provided for provision of an axial bearing function, with the result that the axial forces introduced by the compressor wheel via the compression shaft can be absorbed by both axial air bearings.

The disclosure is based on the recognition that the use of a second axial air bearing constitutes a surprisingly good compromise between an increase in the axial load capacity, that is, the possibility for absorbing axial force, and the necessary installation space for the extension. Even if it actually appears counterintuitive to install an additional bearing, which would inevitably require additional installation space, it has been shown that the axial installation space which is additionally required for the second axial air bearing can lead to a considerably more suitable enclosed volume of the entire compressor than for example a traditional approach of for instance replacing the existing axial air bearing of the known compressor with a radially larger axial air bearing. At the same time, the use of multiple bearings, even when using bearing types which are themselves of simple configuration, makes it possible to achieve a considerable increase in the axial bearing force of the bearing arrangement, and therefore it is not absolutely necessary to resort to the use of expensive special bearings, such as spiral groove bearings. Nevertheless, the disclosure also puts its advantages to use when spiral groove bearings are used, which addresses the improvement in the load capacity with a moderate increase in installation space.

In an embodiment, the compressor is a single-stage compressor, wherein the compressor wheel is arranged on a first end portion of the compressor shaft, and wherein the second axial air bearing is arranged on a second end portion, on the opposite side from the first end portion, of the compressor shaft. Arranging the compressor wheel and the second axial air bearing on opposite sides improves the balance of the rotating masses. Particularly in single-stage compressors, this is, in particular for the bearing arrangement, a major configuration advantage which is beneficial for a longer service life.

In an embodiment, the bearing arrangement includes a radial bearing arrangement. The radial bearing arrangement preferably includes a number of radial bearings arranged between the first axial air bearing and the second axial air bearing. According to the disclosure, “a number” is understood to mean a number of 1 or more units.

The radial bearing arrangement is preferably arranged between the first axial air bearing and the second axial air bearing.

According to various embodiments, the bearing arrangement includes two radial bearings, which may for example be in the form of radial air bearings. The weight and spacing of the axial air bearings with respect to the radial bearings can achieve a favorable weight distribution, and the accessibility of the axial air bearings for maintenance purposes is also provided to a good extent in this way.

In a further embodiment, the first axial air bearing includes a first bearing washer which is configured to revolve in a first air gap, and the second axial air bearing includes a second bearing washer which is configured to revolve in a second air gap.

To achieve the highest possible number of identical parts, it may be preferable for the two axial air bearings to be of identical construction, in particular with regard to the essential elements thereof (foil, foil carrier, bearing washer). This can increase the cost effectiveness, for instance in terms of production and assembly costs.

In an alternatively embodiment, one of the bearing washers, for instance the first bearing washer, is of larger dimensions in the radial direction than the respective other bearing washer, for instance than the second bearing washer. This leads, depending on the extent of the difference, to a different load capacity in the axial direction for the two axial air bearings, which can assist the clear definition of the direction of action of the axial bearing means.

In a further embodiment, the number of radial bearings thus includes a first radial bearing, which is arranged at a first axial spacing from the first axial air bearing, and a second radial bearing, which is arranged at a spacing from the first radial bearing and at a second axial spacing from the second axial air bearing, wherein the second axial spacing and the first axial spacing differ.

Preferably, the second axial spacing is greater than the first axial spacing.

The compressor wheel is generally also arranged on that side of the compressor shaft on which the first axial air bearing sits, such that the rotating masses and tilting moments on that side of the compressor shaft are expectedly greater than on the left-hand side. However, it is possible to achieve in any case partial compensation of the tilting moments by way of a greater spacing of the second axial air bearing from the next radial bearing adjacent thereto, the second radial bearing.

In particular, from the first bearing washer, a first radial force acts on the radial bearing arrangement, and from the second bearing washer, a second radial force acts on the radial bearing arrangement. From the compressor wheel, which is arranged at a third axial spacing from the first or second radial bearing, a third radial force acts on the radial bearing arrangement. The radial forces and spacings each result in tilting moments which act on the radial bearing arrangement via the compressor shaft.

According to various embodiments, the first, second and third spacings are dimensioned in such a way that the resulting tilting moments at least partially, and preferably completely, eliminate one another.

As an alternative or in addition, the first, second and/or third spacings are preferably dimensioned in such a way that in each case radial forces of the same magnitude act on the radial bearings of the bearing arrangement.

In a preferred embodiment, the first air gap and the second air gap are of different dimensions in the direction of the axis of rotation. The background for this is the consideration that at low speeds the bearing washers of the axial air bearings can sometimes still abut against the bearing part which corresponds to them and grind when moving, and it is only when a predetermined lift-off speed is reached that the bearing washer has a spacing on both sides and freely revolves in the air gap. Due to the fact that one of the two air gaps is of somewhat narrower dimensions than the other, for example through narrower dimensioning or narrower tolerancing of the air gap, it can be made possible to predict in which of the two axial air bearings wear will occur during operation at lower speeds. This results in advantages for maintenance planning and predicting the service life of the bearing arrangement. The larger air gap of the one axial air bearing also has a positive effect on the friction losses that occur.

In a further embodiment, the first axial air bearing and/or the second axial air bearing are in the form of foil bearings. Preferably, the bearing washers of each axial air bearing are arranged between two stationary foil disks which are spaced apart from one another by the air gap. The axial air bearings are preferably in the form of bump-type foil bearings, or one of the other foil bearing types. These cost-effective bearing types have, in conjunction with the configuration principle according to the disclosure, a sufficient load capacity for compensating for the axial forces even in single-stage compressors. However, the disclosure does not rule out the use of spiral groove bearings and further bearing types. In a preferred embodiment, one of the axial air bearings, for instance the first axial air bearing, is in the form of a spiral groove bearing, and the other axial air bearing, in that case for instance the second axial air bearing, is in the form of a foil bearing.

According to various embodiments, one of the axial air bearings is in the form of a spiral groove bearing, and the air gap to which it is assigned, for instance the first air gap, is of larger dimensions than the air gap to which the other axial air bearing is assigned, for instance the second air gap.

The disclosure has been described above in a first aspect with reference to the compressor itself. In a further aspect, the disclosure furthermore also relates to a fuel cell system for driving a vehicle, in particular a utility vehicle, including a compressor for supplying air to the cathode side of a fuel cell.

The disclosure achieves the object on which it is based in the case of such a fuel cell system by virtue of the compressor being formed according to one of the preferred embodiments described above. The fuel cell system thus benefits from the same advantages as the compressor according to the first aspect. Preferred embodiments of the compressor are at the same time preferred embodiments of the fuel cell system and vice versa. Reference is therefore made to the statements above in order to avoid repetitions.

### BRIEF DESCRIPTION OF DRAWINGS

The invention will now be described with reference to the drawings wherein:

FIG. 1 shows a schematic illustration of a fuel cell system according to an embodiment; and,

FIG. 2 shows a schematic detail view of a compressor shaft of the fuel cell system according to FIG. 1.

### DETAILED DESCRIPTION

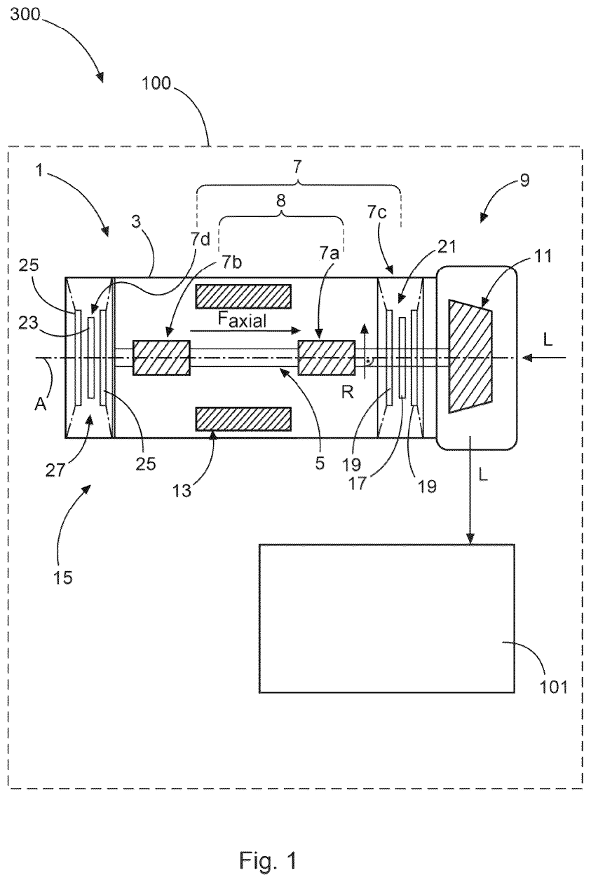

FIG. 1 schematically depicts a fuel cell system 100 for a utility vehicle 300. The fuel cell system 100 includes a fuel cell 101 which is configured to provide electrical energy. For the supply of air, the fuel cell 101 is operatively connected to a compressor 1 which is configured to draw in an air flow L, to compress it, and to feed it to the cathode side of the fuel cell 101.

The compressor 1 includes a compressor housing 3 in which a compressor shaft 5 is rotatably mounted. The compressor shaft 5 is mounted in the compressor housing 3 by means of a bearing arrangement 7, the bearing arrangement 7 including, inter alia, a radial bearing arrangement 8. The radial bearing arrangement 8 includes a first radial bearing 7a and a second radial bearing 7b. Preferably, the two radial bearings 7a, 7b are in the form of radial air bearings, for instance in the form of foil bearings.

The bearing arrangement 7 further includes a first axial air bearing 7c and a second axial air bearing 7d.

A compressor wheel 11 is arranged in a first end portion 9 of the compressor shaft 5 and rotationally conjointly connected to the compressor shaft 5.

The compressor 1 includes an electric machine 13 which is operable as an electric motor and in that case rotationally drives the compressor shaft 5, as a result of which the compressor wheel 11 draws in the air flow L, compresses it and dispenses it in the direction of the fuel cell 101.

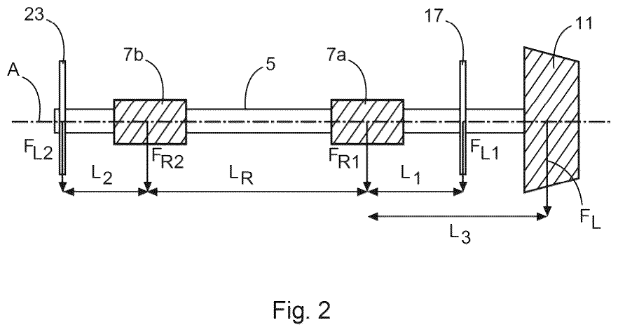

In the embodiment shown, the compressor 1 is in the form of a single-stage compressor. The second axial air bearing 7d is arranged on the compressor shaft 5, in a second end portion 15 on the opposite side from the first end portion 9. As a result, the second axial air bearing 7d performs several relevant functions for the compressor 1: Firstly, the second axial air bearing 7d provides an additional bearing force which significantly increases the axial load capacity of the bearing arrangement 7, that is, the capability to absorb axial forces Fₐₓᵢₐₗ in the direction of an axis of rotation A of the compressor shaft 5. Furthermore, the second axial air bearing 7d contributes to at least partially balancing out the radial forces (cf. FIG. 2) and tilting moments acting on the radial bearing arrangement 8, because the mass from the second axial air bearing 7d, on a side of the radial bearing arrangement 8 facing away from the compressor wheel 11, acts on the compressor shaft 5 and can thus in particular also partially compensate for the radial forces and tilting moments of the first axial air bearing 7c and of the compressor wheel 11.

The first axial air bearing 7c includes a bearing washer 17 which is rotationally conjointly connected to the compressor shaft 5 and is positioned between two stationary foil disks 19. An air gap 21 is formed between the two foil disks 19.

The second axial air bearing 7d also includes a bearing washer 23 which is rotationally conjointly connected to the compressor shaft 5, the second bearing washer 23 being arranged between two stationary foil disks 25 which define between them an air gap 27.

The diameters, that is, radial extents, of the bearing washers 17, 23 may differ according to various embodiments, in order to better define a direction of action in the direction of the axis A, or be identical in order to assist an identical part philosophy. The same applies, conversely, to the respective foil disks 19, 25.

The air gaps 21, 27 may be the same size in the axial direction, but in embodiments, as described above, one of the two gaps 21, 27 may also be narrower than the other, in order to clearly define a wear point and to be able to make maintenance predictions more precisely. This could be, for example, the air gap 27. If maintenance has to be carried out on the bearing arrangement 7, it would then in any case be reliably ensured with regard to the axial air bearings 7c, 7d that it is the second axial air bearing 7d at which wear will occur. And in order to carry out maintenance on this or to exchange this, it would then not be necessary to additionally remove the compressor wheel 11.

FIG. 2 shows, in a rough form and under simplifying assumptions, such as the assumption of a mass-less compressor shaft 5, a balance of forces for the compressor shaft 5 and the radial bearing arrangement 8. The first radial bearing 7a is loaded with a radial force F_{R1}, whereas the second radial bearing 7b is loaded with a radial force F_{R2}. A radial force F_{L1} originates from the first bearing washer 17 of the first axial air bearing 7c, and a radial force F_{LZ} originates from the second bearing washer 23 of the second axial air bearing 7d, each of these radial forces acting on the compressor shaft 5. A radial force F_{V} originates from the compressor wheel 11, and also acts on the compressor shaft 5.

The centers of the two radial bearings 7a, 7b are remote from one another by the spacing L_{R} in the direction of the axis of rotation A, that is, in the axial direction. The first bearing washer 17 is at an axial spacing L₁ from the radial bearing closest to it, namely the first radial bearing 7a. The second bearing washer 23 is at a spacing L₂ from the radial bearing closest to it, namely the second radial bearing 7b. The compressor wheel 11, with its center of mass in the axial direction, is at a spacing L₃ from the radial bearing closest to it, namely, as above, the first radial bearing 7a.

On the basis of the balance of forces and balance of moments for this configuration, the spacings L₁, L₂, and L₃ and L_{R} in the configuration can be coordinated with one another in such a way that the radial loadings F_{R1}, F_{R2} on the radial bearing arrangement 8 are the same, or at least substantially the same. In embodiments, the spacing L₂ will be greater than L₃, and L₃ will be greater than L₁. L_{R} is preferably greater than L₂.

By way of structurally favorable configuration, that is, for example by minimizing the spacings L₁ and L₃ as far as possible, it is possible to establish a bearing concept that is quite compact overall, which offers good utilization of installation space and at the same time makes possible a purely air-bearing-mounted compressor shaft 5 which is balanced advantageously in relation to the prior art. The balancing effect originating from the second axial air bearing 7d makes it possible to achieve long service lives even when using single-stage compressors, such as here in the preferred embodiment. At the same time, the bearing concept permits the use of simple bearing types for the axial air bearings, such as bump-type foil bearings or other foil bearing types.

It is understood that the foregoing description is that of the preferred embodiments of the invention and that various changes and modifications may be made thereto without departing from the spirit and scope of the invention as defined in the appended claims.
1 Compressor
3 Compressor housing
5 Compressor shaft
7 Bearing arrangement:
7a First radial bearing
7b Second radial bearing
7c First axial air bearing
7d Second axial air bearing
8 Radial bearing arrangement
11 Compressor wheel
13 Machine
15 End portion
17 Bearing washer
19 Foil disks
21 Air gap
23 Bearing washer
25 Foil disk
27 Air gap
100 Fuel cell system
101 Fuel cell
300 Utility vehicle
A Axis of rotation, compressor shaft
R Radial direction, relative to A
F_{R1}, F_{R2} Radial force, radial bearing
F_{L1}, F_{L2} Radial force, axial air bearing
F_{V} Radial force, compressor
Fₐₓᵢₐₗ Axial force
L Airflow
L₁, L₂, L₃, L_{R} Axial spacing

1. A compressor for a fuel cell system, the compressor comprising:
a compressor housing;
a compressor wheel;
a rotationally driven compressor shaft operatively connected to said compressor wheel;
a bearing arrangement which supports said compressor shaft in said compressor housing so as to be rotatable about an axis of rotation;
said bearing arrangement including an axial air bearing for absorbing axial forces between said compressor housing and said compressor shaft;
said axial air bearing being a first axial air bearing; and,
said bearing arrangement further including a second axial air bearing arranged at an axial spacing from said first axial air bearing and configured to absorb the axial forces between said compressor housing and said compressor shaft.

2. The compressor of claim 1, wherein the compressor is a single-stage compressor; said compressor wheel is arranged on a first end portion of said compressor shaft; and, said second axial air bearing is arranged on a second end portion, on an opposite side from said first end portion, of said compressor shaft.

3. The compressor of claim 1, wherein said bearing arrangement includes a radial bearing arrangement.

4. The compressor of claim 3, wherein said radial bearing arrangement is arranged between said first axial air bearing and said second axial air bearing.

5. The compressor of claim 1, wherein said first axial air bearing includes a first bearing washer configured to revolve in a first air gap; and, said second axial air bearing includes a second bearing washer configured to revolve in a second air gap.

6. The compressor of claim 5, wherein said first bearing washer is of larger dimensions in a radial direction than said second bearing washer.

7. The compressor of claim 3, wherein said radial bearing arrangement includes a first radial bearing arranged at a first axial spacing from said first axial air bearing and a second radial bearing arranged at a spacing from said first radial bearing and at a second axial spacing from said second axial air bearing; and, said second axial spacing and said first axial spacing differ.

8. The compressor of claim 7, wherein:
said first axial air bearing includes a first bearing washer configured to revolve in a first air gap; and, said second axial air bearing includes a second bearing washer configured to revolve in a second air gap;
from said first bearing washer, a first radial force acts on said radial bearing arrangement;
from said second bearing washer, a second radial force acts on said radial bearing arrangement; and,
from said compressor wheel arranged at a third axial spacing from said first radial bearing or said second radial bearing, a third radial force acts on said bearing arrangement.

9. The compressor of claim 8, wherein said first radial force, said second radial force, and said third radial force and said first axial spacing, said second axial spacing, and said third axial spacing each result in tilting moments which act on said bearing arrangement via said compressor shaft; and, said first axial spacing, said second axial spacing and said third spacing are dimensioned such that the resulting tilting moments partially or completely eliminate one another.

10. The compressor of claim 8, wherein said first axial spacing, said second axial spacing and said third axial spacing are dimensioned such that in each case radial forces of a same magnitude or of at least substantially the same magnitude act on said first radial bearing and said second radial bearing of said bearing arrangement.

11. The compressor of claim 5, wherein said first air gap and said second air gap are of different dimensions in a direction of the axis of rotation.

12. The compressor of claim 1, wherein at least one of said first axial air bearing and said second axial air bearing are foil bearings.

13. The compressor of claim 1, wherein one of said first axial air bearing and said second axial bearing is a spiral groove bearing, and an other of said first axial bearing and said second axial air bearing is a foil bearing.

14. The compressor of claim 1, wherein said first axial air bearing is a spiral groove bearing and said second axial air bearing is a foil bearing.

15. The compressor of claim 1, wherein the fuel cell system is of a utility vehicle.

16. A fuel cell system for driving a vehicle, the fuel cell system comprising:
a compressor for supplying air to a cathode side of a fuel cell;
said compressor including a compressor housing, a compressor wheel, and a rotationally driven compressor shaft operatively connected to said compressor wheel;
said compressor further including a bearing arrangement which supports said compressor shaft in said compressor housing so as to be rotatable about an axis of rotation;
said bearing arrangement including an axial air bearing for absorbing axial forces between said compressor housing and said compressor shaft;
said axial air bearing being a first axial air bearing; and,
said bearing arrangement further including a second axial air bearing arranged at an axial spacing from said first axial air bearing and configured to absorb the axial forces between said compressor housing and said compressor shaft.

17. The fuel cell system of claim 16, wherein the vehicle is a utility vehicle.
